(19) United States
(12) Patent Application Publication
(10) Pub. No.: US 2012/0264659 A1
(43) Pub. Date: Oct. 18, 2012

(54) Methods to Modify Drilling Fluids to Improve Lost Circulation Control

(76) Inventors: Sandeep D. Kulkarni, Pune (IN); Sharath Savari, Pune (IN); Arunesh Kumar, Pune (IN); Shadaab S. Maghrabi, Pune (IN); Dale E. Jamison, Humbie, TX (US); Robert J. Murphy, Kingwood, TX (US)

(21) Appl. No.: 13/150,897

(22) Filed: Jun. 1, 2011

(30) Foreign Application Priority Data
Apr. 15, 2011 (IN) 1100/DEL/2011

(51) Int. Cl. C09K 8/32

(52) U.S. Cl. 507/139

(57) ABSTRACT

Of the many compositions and methods provided here, one method includes providing a drilling fluid comprising a lost circulation material and a base drilling fluid, wherein the base drilling fluid comprises an oleaginous continuous phase and a polar organic molecule, wherein the base drilling fluid has a first normal stress difference magnitude (|N₁|) greater than about 100 Pa; and drilling a portion of a wellbore in a subterranean formation using the drilling fluid.

### BACKGROUND

The present invention relates to compositions and methods related to obtaining optimal drilling fluids that have a desired degree of lost circulation control in a subterranean operation.

A drilling fluid or mud is a specially designed fluid that is circulated through a wellbore as the wellbore is being drilled to facilitate the drilling operation. The various functions of a drilling fluid include removing drill cuttings from the wellbore, cooling and lubricating the drill bit, aiding in support of the drill pipe and drill bit and providing a hydrostatic head to maintain the integrity of the wellbore walls, and prevent well blowouts. Specific drilling fluid systems, which can be oil-based or aqueous-based, are selected to optimize a drilling operation in accordance with the characteristics of a particular geological formation.

Oil-based muds are normally used to drill swelling or sloughing shales, salt, gypsum, anhydrite or other evaporite formations; hydrogen sulfide-containing formations; and high temperature (e.g., greater than about 300° F.) holes, but may be used in other holes penetrating a subterranean formation as well. Oil-based muds are commonly used as treatment fluids for drilling, stimulation, sand control, and completion operations. As used herein, the term “treatment,” or “treating,” refers to any subterranean operation that uses a fluid in conjunction with a desired function and/or for a desired purpose. The term “treatment,” or “treating,” does not imply any particular action by the fluid.

Lost circulation is a common occurrence in drilling operations. In particular, the fluids may enter the subterranean formation via depleted zones, zones of relatively low pressure, lost circulation zones having naturally occurring fractures, weak zones having fracture gradients exceeded by the hydrostatic pressure of the drilling fluid, and so forth. Lost circulation may be a result of treatment fluid being lost to voids within the wellbore and/or the subterranean formation. As a result, the service provided by such fluid is more difficult to achieve. For example, a drilling fluid may be lost to the formation, resulting in the circulation of the fluid in the wellbore being too low to allow for further drilling of the wellbore. In addition, loss of fluids, such as oil-based muds may be quite expensive. Furthermore, the drilling operations may need to be interrupted until the circulation loss problem is solved, which may result in expensive idle rig time. Therefore, a treatment fluid for lost circulation control may be used. By way of nonlimiting example, voids may include pores, vugs, fissures, cracks, and fractures that may be natural or man-made. Several methods may be available for lost circulation control including bridging fractures, providing fluid loss control, sealing surfaces for fluid diversion, or plugging voids. In each method to control lost circulation, the rheological properties of the treatment fluid may be important to the efficacy of treatment. Lost circulation control fluids contain additives that at least partially plug voids, e.g., pores, cracks, or fractures, in a zone causing loss of circulation. These additives are typically called lost circulation materials.

A multitude of lost circulation materials and techniques of placing the lost circulation materials in the loss zone have been developed which demonstrate superior lost circulation control when implemented in aqueous-based fluids versus oil-based fluids. When aqueous-based fluids are used in conjunction with oil-based treatment fluids, significant time and care is taken to prepare the wellbore and subterranean formation for the introduction of an aqueous-based fluid and then for the transition back to the oil-based treatment fluid.

In formations where oil-based treatment fluids are used, a need exists to develop methods that use oil-based fluids for blocking the flow of fluid through pathways such as fractures, loss circulation zones in the subterranean formation, voids or cracks in the cement column and the casing, and so forth.

### SUMMARY OF THE INVENTION

The present invention relates to compositions and methods related to obtaining optimal drilling fluids that have a desired degree of lost circulation control in a subterranean operation.

One embodiment of the present invention is a method comprising: providing a drilling fluid comprising a lost circulation material and a base drilling fluid, wherein the base drilling fluid comprises an oleaginous continuous phase and a polar organic molecule, wherein the base drilling fluid has a |N₁| greater than about 100 Pa; and drilling a portion of a wellbore in a subterranean formation using the drilling fluid.

One embodiment of the present invention is a method comprising: introducing a treatment fluid comprising a lost circulation material and a base treatment fluid into a wellbore penetrating a subterranean formation, wherein the base treatment fluid comprises an oleaginous continuous phase and a polar organic molecule, wherein the base treatment fluid has an |N₁| greater than about 100 Pa; and allowing the lost circulation material to fill a void in a subterranean formation thereby reducing the flow of the treatment fluid or a subsequent fluid into at least a portion of the subterranean formation neighboring the void.

One embodiment of the present invention is a method comprising: providing a base drilling fluid comprising an oleaginous continuous phase; and adding a polar organic molecule to the base drilling fluid in a concentration sufficient to increase an |N₁| of the base drilling fluid to greater than about 100 Pa.

One embodiment of the present invention is a treatment fluid comprising: a lost circulation material; and a base treatment fluid, wherein the base treatment fluid comprises an oleaginous continuous phase and a polar organic molecule, wherein a concentration of the polar organic molecule is sufficient for the base treatment fluid to have a |N₁| greater than about 100 Pa.

The features and advantages of the present invention will be readily apparent to those skilled in the art upon a reading of the description of the preferred embodiments that follows.

### BRIEF DESCRIPTION OF THE DRAWINGS

The following figures are included to illustrate certain aspects of the present invention, and should not be viewed as exclusive embodiments. The subject matter disclosed is capable of considerable modification, alteration, and equivalents in form and function, as will occur to those skilled in the art and having the benefit of this disclosure.

FIG. 1 is a plot of first normal stress difference (N₁) versus shear rate for three base drilling fluids.

FIG. 2 is a plot of N₁ versus shear rate for a base drilling fluid with polar organic molecules added at various concentrations.

FIG. 3 is a schematic of the Tapered Slot apparatus used in the tests described herein.

### DETAILED DESCRIPTION

The present invention relates to compositions and methods related to obtaining optimal drilling fluids that have a desired degree of lost circulation control in a subterranean operation.

Of the many advantages of the present invention, the present invention provides methods for preparing and using oil-based drilling fluids that have similar advantageous features as aqueous-based fluids without the disadvantages of typical oil-based fluids in terms of implementation with respect to lost circulation time and cost. According to the methods of the present invention, this result may be achieved through the addition of a polar organic solvent to the oleaginous base fluid in a desired amount to achieve a first normal stress difference of a magnitude greater than about 100 Pa. By increasing the magnitude of the first normal stress difference, lost circulation materials may have increased efficacy even to a point that allow oil-based fluids to rival the efficacy of aqueous-based fluids. The methods provided herein allow for the determination of optimal concentrations of a polar organic solvent to add to an oil-based fluid in order to achieve effective lost circulation control. Accordingly, the present invention provides for easy insertion of a lost circulation control treatment in oil-based operations thereby reducing idle time and cost. Additionally, the present invention provides methods of lost circulation control that can be implemented in subterranean formations that are not conducive to aqueous-based fluids because of undesirable interactions such as shale swelling or sloughing, salt, gypsum, anhydrite, other evaporite formations, and the like; hydrogen sulfide-containing formations; and high temperature (e.g., greater than about 300° F.) holes.

In one embodiment of the present invention is a method comprising: providing a drilling fluid comprising a lost circulation material and a base drilling fluid, wherein the base drilling fluid comprises an oleaginous continuous phase and a polar organic molecule, wherein the base drilling fluid has a |N₁| greater than about 100 Pa; and drilling a portion of a wellbore in a subterranean formation using the drilling fluid.

In one embodiment of the present invention is a method comprising: introducing a treatment fluid comprising a lost circulation material and a base treatment fluid into a wellbore penetrating a subterranean formation, wherein the base treatment fluid comprises an oleaginous continuous phase and a polar organic molecule, wherein the base treatment fluid has an |N₁| greater than about 100 Pa; and allowing the lost circulation material to fill a void in a subterranean formation thereby reducing the flow of the treatment fluid or a subsequent fluid into at least a portion of the subterranean formation neighboring the void.

In one embodiment of the present invention is a method comprising: providing a base drilling fluid comprising an oleaginous continuous phase; and adding a polar organic molecule to the base drilling fluid in a concentration sufficient to increase an |N₁| of the base drilling fluid to greater than about 100 Pa.

In one embodiment of the present invention is a treatment fluid comprising: a lost circulation material; and a base treatment fluid, wherein the base treatment fluid comprises an oleaginous continuous phase and a polar organic molecule, wherein a concentration of the polar organic molecule is sufficient for the base treatment fluid to have a |N₁| greater than about 100 Pa.

According to the methods of the present invention, the flow of a fluid in a void may be classified as a complex extensional flow where the extensional flow viscosity depends on the first normal stress difference (N₁). The first normal stress difference is defined as N₁=τₓₓ−τ_{yy} where τₓₓ and τ_{yy} are normal stresses of the material in velocity and velocity-gradient directions, respectively. The magnitude of N₁ is a measure of the degree of fluid visco-elasticity which for a visco-inelastic fluid is about 0. As used herein, the magnitude of N₁ is the absolute value of N₁ and may be expressed as |N₁|. The Normal Stress Difference (N₁) may be measured by methods known to one skilled in the art. One skilled in the art should understand a plurality of procedures and parameters including shear ramp rate, gap distance, temperature, and pressure that may be used in measuring the N₁. By way of nonlimiting example, the N₁ may be measured via rotational rheometry testing using a parallel plate geometry. The measurements may be conducted at 25° C. and atmospheric pressure with the gap between the plates including a gap set at about 1 mm. An amount of base drilling fluid may be placed in the gap which is then subjected to a shear rate ramp including from about 0.1 s⁻¹ to about 50 s⁻¹. A plurality of data points (shear stress and N₁ values) may be collected at selected shear rates. When N₁ is measured with a parallel plate geometry of an advanced rheometer, the negative value of N₁ implies that the Rheometer plates are pulled together, as is the case in some examples provided herein.

Treatment fluids suitable for lost circulation control may comprise a base treatment fluid with a |N₁| greater than about 100 Pa when measured at a shear rate of greater than about 5s⁻¹ as measured on the parallel plate geometry of an Advanced Rheometer.

In some embodiments, a treatment fluid of the present invention may comprise a lost circulation material and a base treatment fluid wherein the base treatment fluid contains an oleaginous continuous phase and a polar organic molecule. In some embodiments of the present invention, a polar organic molecule may be present in a base treatment fluid such that |N₁| of the base treatment fluid is greater than about 100 Pa.

Without being bound by theory or mechanism, it is believed that a polar organic molecule added to the base treatment fluid may provide for at least one of the following: (1) an increase in the base treatment fluid elasticity, (2) a decrease in the polarity difference between an internal and an external phase of an emulsified base treatment fluid, (3) a synergistic effect between other components in the base treatment fluid, (4) a change in lubricity of the base treatment fluid, and/or (5) a change in how lost circulation materials in the treatment fluid interact with each other and the subterranean formation.

It should be noted that when “about” is provided at the beginning of a numerical list, “about” modifies each number of the numerical list.

A suitable oleaginous continuous phase for use in the present invention includes any oleaginous continuous phase fluid suitable for use in subterranean operations. By way of nonlimiting example, an oleaginous continuous phase may include an alkane, an olefin, an aromatic organic compound, a cyclic alkane, a paraffin, a diesel fluid, a mineral oil, a desulfurized hydrogenated kerosene, and any combination thereof. In some embodiments, the base treatment fluid may include an invert emulsion with an oleaginous continuous phase and an aqueous discontinuous phase. Suitable invert emulsions may have an oil-to-water ratio from a lower limit of greater than about 50:50, 55:45, 60:40, 65:35, 70:30, 75:25, or 80:20 to an upper limit of less than about 100:0, 95:5, 90:10, 85:15, 80:20, 75:25, 70:30, or 65:35 by volume in the base treatment fluid, where the amount may range from any lower limit to any upper limit and encompass any subset between the upper and lower limits. Some of the lower limits listed above are greater than some of the listed upper limits, one skilled in the art will recognize that the selected subset will require the selection of an upper limit in excess of the selected lower limit.

Polar organic molecules for use in the present invention may be any molecule with a dielectric constant greater than about 2. Polar organic molecules suitable for use in the present invention may include any polar organic molecule including protic and aprotic organic molecules. Suitable protic compounds may include organic molecules with at least one functional group to include an alcohol, an aldehyde, an acid, an amine, an amide, a thiol, and any combination thereof. Suitable aprotic compounds may include organic molecules with at least one functional group to include an ester, an ether, a nitrile, a nitrite, a nitrile, a ketone, a sulfoxide, a halogen, and any combination thereof. Suitable polar organic molecules may be cyclic compound including, but not limited to, pyrrole, pyridine, furan, and derivatives thereof. Suitable polar organic molecules may include an organic molecule with multiple functional groups including mixtures of protic and aprotic groups. In some embodiments, a base treatment fluid may comprise multiple polar organic molecules.

The polar organic molecule used in the present invention may be added to a base treatment fluid in a sufficient concentration such that |N₁| for the base treatment fluid is greater than about 100 Pa. In some embodiments, a polar organic molecule may be present in a base treatment fluid in an amount from a lower limit of greater than about 0.01%, 0.1%, 0.5%, 1%, 5%, or 10% to an upper limit of less than about 100%, 90%, 75%, 50%, 25%, 20%, 15%, 10%, 5%, 1%, 0.5%, or 0.1% by volume of the base treatment fluid, where the amount may range from any lower limit to any upper limit and encompass any subset between the upper and lower limits. Some of the lower limits listed above are greater than some of the listed upper limits, one skilled in the art will recognize that the selected subset will require the selection of an upper limit in excess of the selected lower limit. By way of nonlimiting example, a base drilling fluid may be an ester, therefore 100% of the base drilling fluid would be a polar organic compound.

In some embodiments, the treatment fluid may contain a lost circulation material and a base treatment fluid. A lost circulation material for use in the present invention may be any known lost circulation material, bridging agent, fluid loss control agent, diverting agent, or plugging agent suitable for use in a subterranean formation. The lost circulation material may be natural or synthetic, degradable or nondegradable, particles or fibers, and mixtures thereof. It should be understood that the term “particulate” or “particle,” as used in this disclosure, includes all known shapes of materials, including substantially spherical materials, fibrous materials, high-to-low aspect ratio materials, polygonal materials (such as cubic materials), and mixtures thereof.

Suitable lost circulation materials include, but are not limited to, sand, shale, bauxite, ceramic materials, glass materials, metal pellets, high strength synthetic fibers, cellulose flakes, wood, resins, polymer materials (crosslinked or otherwise), polytetrafluoroethylene materials, nut shell pieces, cured resinous particulates comprising nut shell pieces, seed shell pieces, cured resinous particulates comprising seed shell pieces, fruit pit pieces, cured resinous particulates comprising fruit pit pieces, composite particulates, and any combination thereof. Suitable composite particulates may comprise a binder and a filler material wherein suitable filler materials include silica, alumina, fumed carbon, carbon black, graphite, mica, titanium dioxide, meta-silicate, calcium silicate, kaolin, talc, zirconia, boron, fly ash, hollow glass microspheres, solid glass, and any combination thereof.

In some embodiments, a lost circulation material may be degradable. Nonlimiting examples of suitable degradable materials that may be used in conjunction with the present invention include, but are not limited to, degradable polymers (crosslinked or otherwise), dehydrated compounds, and/or mixtures of the two. In choosing the appropriate degradable material, one should consider the degradation products that will result. As for degradable polymers, a polymer is considered to be “degradable” herein if the degradation is due to, inter alia, chemical and/or radical process such as hydrolysis, oxidation, enzymatic degradation, or UV radiation. Suitable examples of degradable polymers for a lost circulation material for use in the present invention that may be used include, but are not limited to, those described in the publication of Advances in Polymer Science, Vol. 157 entitled “Degradable Aliphatic Polyesters” edited by A. C. Albertsson. Polymers may be homopolymers, random, linear, crosslinked, block, graft, and star- and hyper-branched. Such suitable polymers may be prepared by polycondensation reactions, ring-opening polymerizations, free radical polymerizations, anionic polymerizations, carbocationic polymerizations, and coordinative ring-opening polymerization, and any other suitable process. Specific examples of suitable polymers include polysaccharides such as dextran or cellulose; chitin; chitosan; proteins; orthoesters; aliphatic polyesters; poly(lactide); poly(glycolide); poly(∈-caprolactone); poly(hydroxybutyrate); poly(anhydrides); aliphatic polycarbonates; poly(orthoesters); poly(amino acids); poly(ethylene oxide); and polyphosphazenes. Of these suitable polymers, aliphatic polyesters and polyanhydrides are preferred.

Dehydrated compounds may be used in accordance with the present invention as a degradable solid particulate. A dehydrated compound is suitable for use in the present invention if it will degrade over time as it is rehydrated. For example, a particulate solid anhydrous borate material that degrades over time may be suitable. Specific examples of particulate solid anhydrous borate materials that may be used include, but are not limited to, anhydrous sodium tetraborate (also known as anhydrous borax) and anhydrous boric acid. Certain degradable materials may also be suitable as compositions of a solid degradable particulate for use in the present invention. One example of a suitable blend of materials is a mixture of poly(lactic acid) and sodium borate where the mixing of an acid and base could result in a neutral solution where this is desirable. Another example would include a blend of poly(lactic acid) and boric oxide, a blend of calcium carbonate and poly(lactic) acid, a blend of magnesium oxide and poly(lactic) acid, and the like. In certain preferred embodiments, the degradable material is calcium carbonate plus poly(lactic) acid. Where a mixture including poly(lactic) acid is used, in certain preferred embodiments the poly(lactic) acid is present in the mixture in a stoichiometric amount, e.g., where a mixture of calcium carbonate and poly(lactic) acid is used, the mixture comprises two poly(lactic) acid units for each calcium carbonate unit. Other blends that undergo an irreversible degradation may also be suitable, if the products of the degradation do not undesirably interfere with either the conductivity of the filter cake or with the production of any of the fluids from the subterranean formation.

In some embodiments, a lost circulation material may be present in a treatment fluid in an amount from a lower limit of greater than about 0.01 pounds per barrel (PPB), 0.05 PPB, 0.1 PPB, 0.5 PPB, 1 PPB, 3 PPB, 5 PPB, or 10 PPB to an upper limit of less than about 150 PPB, 100 PPB, 50 PPB, 25 PPB, 10 PPB, 5 PPB, 4 PPB, 3 PPB, 2 PPB, 1 PPB, or 0.5 PPB in the treatment fluid, where the amount may range from any lower limit to any upper limit and encompass any subset between the upper and lower limits. Some of the lower limits listed above are greater than some of the listed upper limits, one skilled in the art will recognize that the selected subset will require the selection of an upper limit in excess of the selected lower limit.

The methods and compositions of the present invention may be suitable for use in nearly all subterranean formations. In some embodiments, the subterranean formation may be a swelling or sloughing shale, a salt formation, a gypsum formation, an anhydrite formation, other evaporite formations, a hydrogen sulfide-containing formation, a hot (e.g., greater than about 300° F.) formation, and/or a hard fracture rock formation.

Although primarily described in terms of lost circulation control for drilling fluids, the teachings of the present invention and the methods and compositions of the present invention may be used in many different types of subterranean treatment operations. Such operations include, but are not limited to, drilling operations, lost circulation operations, stimulation operations, sand control operations, completion operations, acidizing operations, scale inhibiting operations, water-blocking operations, clay stabilizer operations, fracturing operations, frac-packing operations, gravel packing operations, wellbore strengthening operations, and sag control operations. The methods and compositions of the present invention may be used in full-scale operations or pills. As used herein, a “pill” is a type of relatively small volume of specially prepared treatment fluid placed or circulated in the wellbore.

In some embodiments, an additive may optionally be included in a base treatment fluid used in the present invention. Examples of such additives may include, but are not limited to, salts; weighting agents; inert solids; fluid loss control agents; emulsifiers; dispersion aids; corrosion inhibitors; emulsion thinners; emulsion thickeners; viscosifying agents; high-pressure, high-temperature emulsifier-filtration control agents; surfactants; particulates; proppants; lost circulation materials; pH control additives; foaming agents; breakers; biocides; crosslinkers; stabilizers; chelating agents; scale inhibitors; gases; mutual solvents; oxidizers; reducers; and any combination thereof. A person of ordinary skill in the art, with the benefit of this disclosure, will recognize when an additive should be included in a base treatment fluid, as well as an appropriate amount of said additive to include.

To facilitate a better understanding of the present invention, the following examples of preferred embodiments are given. In no way should the following examples be read to limit, or to define, the scope of the invention.

### EXAMPLES

The base drilling fluids tested in these examples are HYDROGAURD® (an aqueous-based drilling fluid, available from Halliburton Energy Services, Inc. in Houston, Tex.), INNOVERT® (an oil-based drilling fluid with an oil-base of mineral oil and alkanes, available from Halliburton Energy Services, Inc. in Houston, Tex.), and ACCOLADE® (an oil-based drilling fluid with an oil-base of olefins and esters, available from Halliburton Energy Services, Inc. in Houston, Tex.). The mud weight for each system was 12 PPG. Each mud was hot rolled at 200° F. for a period of 16 hours prior to testing.

The shear viscosity was measured using a FANN-35 SA Rheometer at 120° F.

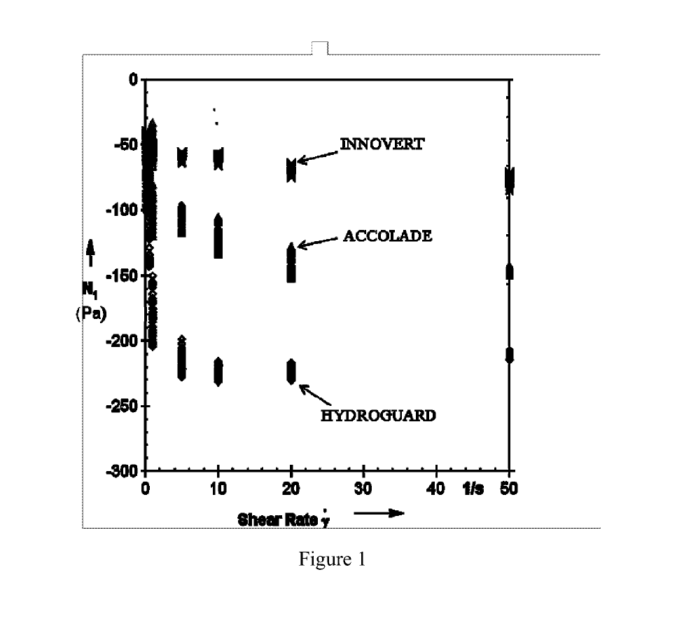

The first normal stress difference (N₁) was measured via rotational rheometry test using a MCR-301 Model Anton Paar Rheometer using PP-50 parallel plate geometry. The measurements were conducted at 25° C. and atmospheric pressure with the gap between the plates set at 1 mm. About 2-3 mL of base drilling fluid was placed in the gap which was then subjected to shear rate ramp from 0.1 s⁻¹ to 50 s⁻¹. Fifty data points (shear stress and N₁ values) were collected at each selected shear rate. The test duration was about one to three hours. FIG. 1 shows N₁ vs. shear rate.

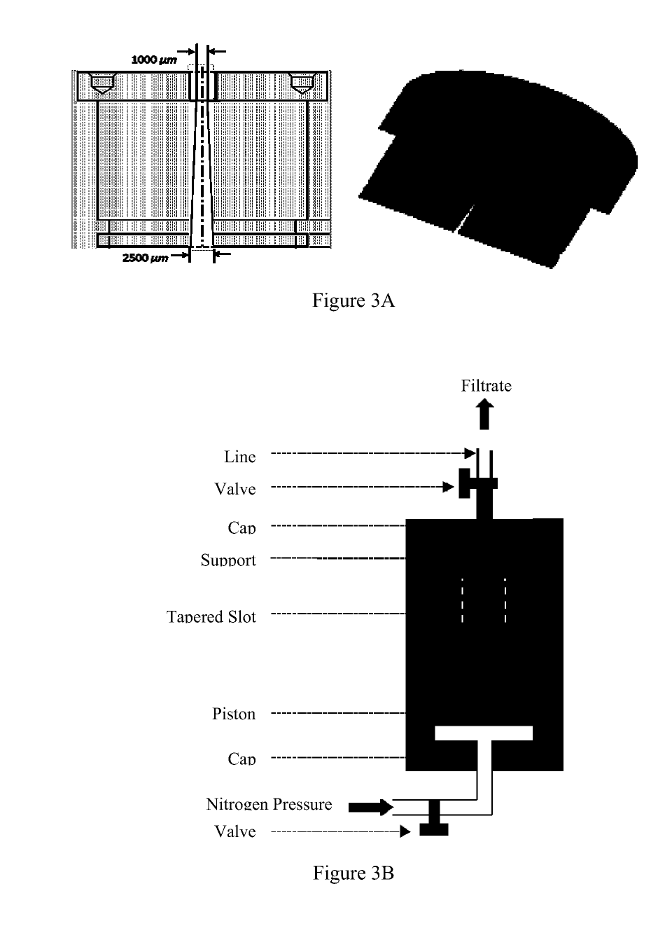

Lost circulation efficiency, or lost circulation control, was measured with a Particle Plugging Apparatus. The Particle Plugging Apparatus (FIG. 3B) consists of a 500-mL volume cell that has a movable piston at the bottom. At the top, the cell has an assembly for sealing the filter media in while testing. The cell is positioned with pressure applied from the bottom of the cell and the filtrate collected from the top. This prevents other components of the drilling fluid that settle during the static period of the test from contributing to the performance of the particulate. The cell pressure is applied by a two-stage hydraulic pump or using a nitrogen pressure line. Pressure is transferred to the drilling fluid through the floating piston in the cell. The filter media that is employed in the particle plugging apparatus test as part of this test is the tapered slot (schematic in FIG. 3A). The performance of the particulate is determined by the ability of the particulate to form an impermeable plug or bridge in the filtering media and to arrest the drilling fluid loss.

Lost circulation material of PANEX®-35 (a tow weave carbon fiber, available from Zoltek Corporation in St. Louis, Mo.), ground marble with d(50)=1200 μm, and resilient graphite carbon with d(50)=1000 μm were added to a drilling fluid sample at a concentration of 0.49 PPB, 50 PPB, and 8 PPB, respectively. 250 mL of the resultant sample was pressurized against a tapered slot where the opening of the slot tapers from one end to another over a fixed length physically resembling a fracture. FIG. 3A provides a schematic representation of the tapered slot used with opening dimensions of 1000 μm and 2500 μm. FIG. 3B provides a representation of the particle plugging apparatus used in these tests. The volume of fluid able to pass through the tapered slot before being plugged by the lost circulation material was measured.

### Example 1

The rheological properties of the three drilling fluids were compared without a lost circulation material added. The shear viscosity for all three drilling fluids are similar. However, as shown in FIG. 1, there are significant differences in the first normal stress difference (N₁) for the three drilling fluids at a shear rate greater than 5 s⁻¹.

### Example 2

The drilling fluid loss control was measured for the three drilling fluids. Both HYDROGAURD® and ACCOLADE® provided similar fluid loss control of 15-20 mL while INNOVERT® provided no drilling fluid loss control.

### Example 3

The oil-to-water ratio was adjusted and viscosifiers were added to INNOVERT® in an attempt to achieve higher |N₁| values and improve the drilling fluid loss control. No appreciable change in either measurement was observed.

### Example 4

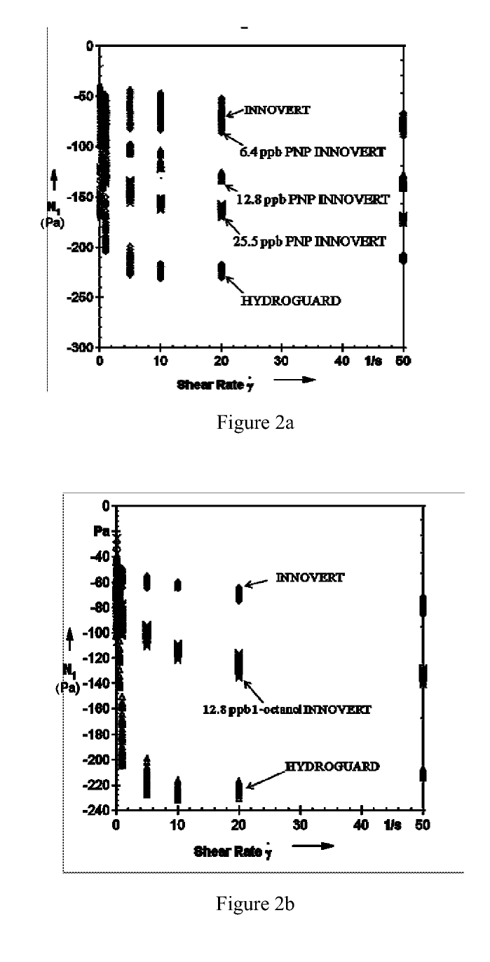

Samples of INNOVERT® were prepared with 6.4 PPB, 12.8 PPB, and 25.5 PPB N-propoxy propanol and 12.8 PPB 1-octanol. FIG. 2 shows the first normal stress difference of the four samples as compared to INNOVERT® and HYDROGAURD®. With the addition of increasing amounts of polar organic molecules |N₁| of INNOVERT® increased. Correspondingly, in drilling fluid loss control tests, no drilling fluid loss control is seen with INNOVERT® or INNOVERT® with 6.4 PPB N-propoxy propanol. However, 30 mL, 20 ml and 20 mL of controlled drilling fluid loss was observed with 12.8 PPB N-propoxy propanol, 25.5 PPB N-propoxy propanol, and 12.8 PPB 1-octanol added to INNOVERT®, respectively.

Therefore, the present invention is well-adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patents or other documents that may be incorporated herein by reference, the definitions that are consistent with this specification should be adopted.

What is claimed is:

1. A method comprising:
providing a drilling fluid comprising a lost circulation material and a base drilling fluid,
wherein the base drilling fluid comprises an oleaginous continuous phase and a polar organic molecule,
wherein the base drilling fluid has a |N₁| greater than about 100 Pa; and
drilling a portion of a wellbore in a subterranean formation using the drilling fluid.

2. The method of claim 1, wherein the lost circulation material is placed in a void in the subterranean formation.

3. The method of claim 1, wherein the lost circulation material comprises a fiber and/or a particulate.

4. The method of claim 1, wherein the base drilling fluid is an invert emulsion with the oleaginous continuous phase and an aqueous discontinuous phase.

5. The method of claim 1, wherein the oleaginous continuous phase comprises a fluid selected from the group consisting of an alkane, an olefin, an aromatic organic compound, a cyclic alkane, a paraffin, a diesel fluid, a mineral oil, a desulfurized hydrogenated kerosene, and any combination thereof.

6. The method of claim 1, wherein the polar organic molecule is a protic organic molecule, an aprotic organic molecule, and any combination thereof.

7. The method of claim 1, wherein the polar organic molecule is present in the base drilling fluid in an amount of about 0.01% to about 100% by volume of the oleaginous continuous phase.

8. The method of claim 1, wherein the base drilling fluid further comprises an additive selected from the group consisting of a salt; a weighting agent; an inert solid; a fluid loss control agent; an emulsifier; a dispersion aid; a corrosion inhibitor; an emulsion thinner; an emulsion thickener; a viscosifying agent; a high-pressure, high-temperature emulsifier-filtration control agent; a surfactant; a particulate; a proppant; a lost circulation material; a pH control additive; a foaming agent; a breaker; a biocide; a crosslinker; a stabilizer; a chelating agent; a scale inhibitor; a gas; a mutual solvent; an oxidizer; a reducer; and any combination thereof.

9. A method comprising:
introducing a treatment fluid comprising a lost circulation material and a base treatment fluid into a wellbore penetrating a subterranean formation,
wherein the base treatment fluid comprises an oleaginous continuous phase and a polar organic molecule,
wherein the base treatment fluid has an |N₁| greater than about 100 Pa; and
allowing the lost circulation material to fill a void in a subterranean formation thereby reducing the flow of the treatment fluid or a subsequent fluid into at least a portion of the subterranean formation neighboring the void.

10. The method of claim 9, wherein the lost circulation material comprises a fiber and/or particulate.

11. The method of claim 9, wherein the base treatment fluid is an invert emulsion with the oleaginous continuous phase and an aqueous discontinuous phase.

12. The method of claim 9, wherein the oleaginous continuous phase comprises a fluid selected from the group consisting of an alkane, an olefin, an aromatic organic compound, a cyclic alkane, a paraffin, a diesel fluid, a mineral oil, a desulfurized hydrogenated kerosene, and any combination thereof.

13. The method of claim 9, wherein the polar organic molecule is a protic organic molecule, an aprotic organic molecule, and any combination thereof.

14. A method comprising:
providing a base drilling fluid comprising an oleaginous continuous phase; and
adding a polar organic molecule to the base drilling fluid in a concentration sufficient to increase an |N₁| of the base drilling fluid to greater than about 100 Pa.

15. The method of claim 14 further comprising introducing the drilling fluid into a wellbore penetrating a subterranean formation.

16. The method of claim 14 further comprising adding a lost circulation material to the base drilling fluid, and wherein the lost circulation material comprises a fiber and/or particulate.

17. The method of claim 14, wherein the base drilling fluid is an invert emulsion with the oleaginous continuous phase and an aqueous discontinuous phase.

18. The method of claim 14, wherein the oleaginous continuous phase comprises a fluid selected from the group consisting of an alkane, an olefin, an aromatic organic compound, a cyclic alkane, a paraffin, a diesel fluid, a mineral oil, a desulfurized hydrogenated kerosene, and any combination thereof.

19. The method of claim 14, wherein the polar organic molecule is a protic organic molecule, an aprotic organic molecule, and any combination thereof.

20. A treatment fluid comprising:
a lost circulation material; and
a base treatment fluid,
wherein the base treatment fluid comprises an oleaginous continuous phase and a polar organic molecule,
wherein a concentration of the polar organic molecule is sufficient for the base treatment fluid to have a |N₁| greater than about 100 Pa.
